(19) United States
(12) Patent Application Publication
(10) Pub. No.: US 2009/0149198 A1
(43) Pub. Date: Jun. 11, 2009

(54) SYSTEM AND METHOD FOR TRACKING POSITION

(75) Inventors: Hong-Soon NAM, DaeJeon (KR); Mi-Kyung Oh, Gyeongbuk (KR); Cheol-Hyo Lee, DaeJeon (KR); Jae-Young Kim, DaeJeon (KR); Kwang-Roh Park, Seoul (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/182,752

(22) Filed: Jul. 30, 2008

(30) Foreign Application Priority Data
Dec. 10, 2007 (KR) 10-2007-127909

(51) Int. Cl. H04Q 7/20; G01S 5/02

(52) U.S. Cl. 455/456.2; 342/387

(57) ABSTRACT

Provided are a position tracking system and a position tracking method. The position tracking system includes at least one target node, a plurality of reference nodes having position information, and a position determination device. An arbitrary reference node among the reference nodes and the target node utilize a distance measurement message to measure a first time of arrival (TOA) and then transmit the first TOA to the position determination device. At least two other reference nodes adjacent to the arbitrary reference node and the target node listen to the distance measurement message to measure a second TOA and then transmit the second TOA to the position determination device, in order to track a position of the target node.

### CROSS-REFERENCE TO RELATED APPLICATIONS

This application claims priority under 35 U.S.C. §119 to Korean Patent Application No. 10-2007-127909, filed on Dec. 10, 2007, the disclosure of which is incorporated herein by reference in its entirety.

### BACKGROUND OF THE INVENTION

1. Field of the Invention

The present disclosure relates to a system and a method for tracking position, and more particularly, to a system and a method for tracking a position of a target node in a wireless personal area network.

This work was supported by the IT R&D program of MIC/IITA.

[2006-S-070-02, Development of Cognitive Wireless Home Networking System]

2. Description of the Related Art

In general, a wireless personal area network (WPAN) is a kind of a sensor network and delivers a relatively small amount of information between users within a somewhat short range. Additionally, the WPAN can be directly used for communication among peripheral devices, without a cable.

There are many occasions where mobile target nodes need to be positioned in the WPAN. For this, the WPAN generally includes a coordinator administrating a network, at least three reference nodes measuring distance, a plurality of target nodes, and one position determination device.

The position determination device can share a plurality of networks, administrate position information around itself position information of reference nodes, and information concerning clock errors of reference nodes and target nodes, and function as a reference node by itself.

The coordinator manages the WPAN. One coordinator may exist in one WPAN. The coordinator manages WPAN frequency channels and IDs, subscriptions and withdrawals of target nodes, and member information. The coordinator also functions as a reference node.

A reference node is a node recognizing a position of a target device, is well aware of its position, and measures distance with respect to a target node of which position needs to be tracked. In general, the coordinator and the reference node have few limitations in consuming energy.

The target node is a wireless node for communication. A plurality of target nodes may exist in one WPAN. The target nodes are stationary or mobile. The target nodes generally have limitations in consuming energy, such that they operate with low power consumption.

Examples of a method of tracking a position of a target node to be positioned in the WPAN are a time of arrival (TOA) method, and a time difference of arrival (TDOA) method. Generally, it is apparent to those skilled in the art that distance information for at least three reference nodes are required in order to recognize a position of one target node in a case of two dimensional plane, and distance information for at least four reference nodes are required in order to recognize a position of one target node in a case of three dimensional space.

First, the TOA method measures a time of receiving a distance measurement message in a reception node in order to calculate a signal propagation time between two nodes, and then calculates distance by multiplying the signal propagation time by propagation velocity. The TOA method includes a method of calculating distance by measuring a signal propagation time in a synchronous network and a method of calculating distance by measuring a round trip delay time in an asynchronous network. The method of calculating distance in an asynchronous network is called a two-way ranging (TWR) method.

FIG. 1 is an exemplary view illustrating a process of tracking position through TOA of a TWR method used in an asynchronous network.

Referring to FIG. 1, a related art device for tracking position includes first to third reference nodes 30, 40, and 50, a WPAN with a target node 20, and a position determination device 10. One of the three reference nodes 30, 40, and 50 can be a coordinator that administrates the WPAN.

The TWR method in a related art WPAN measures a signal propagation time between the first reference node 30 and the target node 20, and requests the first reference node 30 to send distance measurement for the target node 20. Accordingly, the first reference node 30 sends a distance measurement request message (request) to the target node 20. Then, the target node 20 sends a reply message (ack) after receiving the distance measurement request message (request). The target node 20 transmits the reply signal (t_{reply, d}) to the first reference node 30, which is a required time for transmitting the reply message (ack) after receiving the distance measurement request message (request). Then, the first reference node 30 receives a transmission time of the distance measurement request message (request) and a reply message (ack) from the target node 20 in order to calculate a required round trip delay time (T_{round, d}). Next, the first reference node 30 transmits the required round trip delay time (T_{round, d}) to the position determination device 10 in addition to TOA received from the target node 20.

Therefore, the position determination device 10 calculates a signal propagation time (t_{p, r1-d}) between two nodes by using Equation (1). As explained in Equation (2), the signal propagation time (t_{p, r1-d}) between two nodes, obtained by using Equation (1), is multiplied by propagation velocity to calculate the distance (d_{r1-d}) between the first reference node 30 and the target node 20.

t_{p, r1-d}=(t_{round, d}−t_{reply, d})/² (1)

d_{r1-d}=c.t_{p, r1-d} (2)

where t_{round, d} represents a round trip delay time that is a time difference between a time of receiving a reply message and a time of receiving a distance measurement request message in the first reference node 30, and t_{reply, d} represents a reply time that is a time difference between a time of receiving a distance measurement request message from the first reference node 30 and a time of transmitting a reply message in the target node 20.

On the other hand, at least three distance information is required to track a position of the target node 20 in a case of a two dimensional plane. As illustrated in FIG. 1, to measure the distance dᵣ₁₋ₚ between the first reference node 30 and the target node 20, two distance measurement messages corresponding to a distance measurement request message and a reply message are required, and thus, six distance measurement messages (distance measurement request messages and reply messages) are required to obtain three pieces of distance information.

In this case, as the number of target nodes to be positioned increases, the number of messages for distance measurement increases in proportion to the number of target nodes because distance for each target node needs to be measured. Accordingly, the number of messages in the WPAN increases traffic volume, thereby prolonging an operating time and raising power consumption of the target node 20. Moreover, as the number of target nodes is increased, traffic congestion occurs in a career sense multiple access (CSMA) network.

Furthermore, because t_{round, r1} is measured by a clock of the first reference node 30 and t_{reply, d} is measured by a clock of the target node 20, errors occur as much as t_{p, r1-r2} due to difference between the two clocks. To correct this clock error, provided is a symmetric double-sided two-way ranging (SDS-TWR) method for correcting errors by performing TWR on two nodes, respectively, in IEEE802.15.4a. This method can correct the clock errors by performing TWR twice, but causes more traffic congestion because of distance measurement.

On the other hand, the TDOA method can be easily realized when reference nodes are not synchronized with a target node, and can track a position of the target node by using a hyperbolic function through TDOA, i.e., difference information of TOA.

However, since the TDOA method measures TOA by synchronizing three base stations, there is limitation in applying the TDOA method to the WPAN.

Because the WPAN includes a plurality of target nodes that utilize limited energy in one network, required is a method of tracking positions of target nodes through an efficient distance measuring process capable of reducing traffic volume and power consumption in a network.

### SUMMARY

Therefore, an object of the present invention is to provide a system and a method for efficiently tracking a position of a target node by reducing traffic volume and power consumption in a WPAN.

Another object of the present invention is to provide a system and a method for tracking a position of a target node through TOA of a TWR method by measuring distance between a target node and one reference node and receiving a message for distance measurement in other reference nodes in a WPAN.

Another object of the present invention is to provide a system and a method for tracking a position of a target node by performing a distance measurement process on reference nodes and receiving a message in a target node to measure a relative difference of TOA in a WPAN.

Another object of the present invention is to provide a system and a method for tracking a position of a target node by efficiently correcting a clock error between a reference node and a target node in a WPAN.

To achieve these and other advantages and in accordance with the purpose(s) of the present invention as embodied and broadly described herein, a position tracking system in accordance with an aspect of the present invention includes: at least one target node; a plurality of reference nodes having position information; and a position determination device. An arbitrary reference node among the reference nodes and the target node utilize a distance measurement message to measure a first time of arrival (TOA) and then transmit the first TOA to the position determination device. At least two other reference nodes adjacent to the arbitrary reference node and the target node listen to the distance measurement message to measure a second TOA and then transmit the second TOA to the position determination device, in order to track a position of the target node.

To achieve these and other advantages and in accordance with the purpose(s) of the present invention, a position tracking system in accordance with another aspect of the present invention includes: at least one target node; a plurality of reference nodes having position information; and a position determination device for tracking a position of a target node. An arbitrary reference node among the reference nodes utilizes a distance measurement message to measure a first TOA between the reference nodes, and then transmit the first TOA to the position determination device. The target node listens to the distance measurement message to measure a second TOA and then transmits the second TOA to the position determination device. The position determination device measures a time difference of arrival (TDOA) of difference information between the first and second TOAs in order to track a position of the target node.

To achieve these and other advantages and in accordance with the purpose(s) of the present invention, a position tracking method using a position tracking device, the position tracking device including at least one target node, a plurality of reference nodes having position information, and a position determination device tracking a position of a target node, in accordance with another aspect of the present invention includes: measuring a first TOA by using a distance measurement message in an arbitrary reference node among the reference nodes and the target node; measuring a second TOA by listening to the distance measurement message in reference nodes adjacent to the arbitrary reference node and the target node; and tracking a position of the target node through the first and second TOAs in the position determination device.

To achieve these and other advantages and in accordance with the purpose(s) of the present invention, a position tracking method using a position tracking device, the position tracking device including at least one target node, a plurality of reference nodes having position information, and a position determination device tracking a position of a target node, in accordance with another aspect of the present invention includes: measuring a first TOA between the reference nodes through a distance measurement message in an arbitrary reference node among the reference nodes; measuring a second TOA by listening to the distance measurement message in the target node; and tracking a position of the target node by measuring a TDOA through the first and second TOAs in the position determination device.

According to the present invention, the number of required distance measurement messages is reduced by one third in a case of second dimensional plane, and by one quarter in a case of a three dimensional space, compared to a method for tracking a position of a node through a related art TOA method. Accordingly, traffic volume of a network is decreased, and a position of a node can be quickly tracked. In addition, an operating time and power consumption of a node can be also reduced.

Moreover, because a TDOA method, which performs a distance measuring process between reference nodes, needs the predetermined number of distance measurement messages regardless of the number of target nodes, it is efficient in a WPAN with a great number of target nodes.

Furthermore, clock errors between target nodes are corrected by measuring distance between nodes, such that distance accuracy is improved to precisely track a current position of a specific node.

Additionally, according to a method for tracking position through an efficient distance measuring process, network traffic volume for tracking positions of target nodes and power consumption of nodes are reduced in a WPAN with a great number of target nodes having limited energy in one network.

The foregoing and other objects, features, aspects and advantages of the present invention will become more apparent from the following detailed description of the present invention when taken in conjunction with the accompanying drawings.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is an exemplary view illustrating a process of tracking position through TOA of a TWR method used in an asynchronous network;

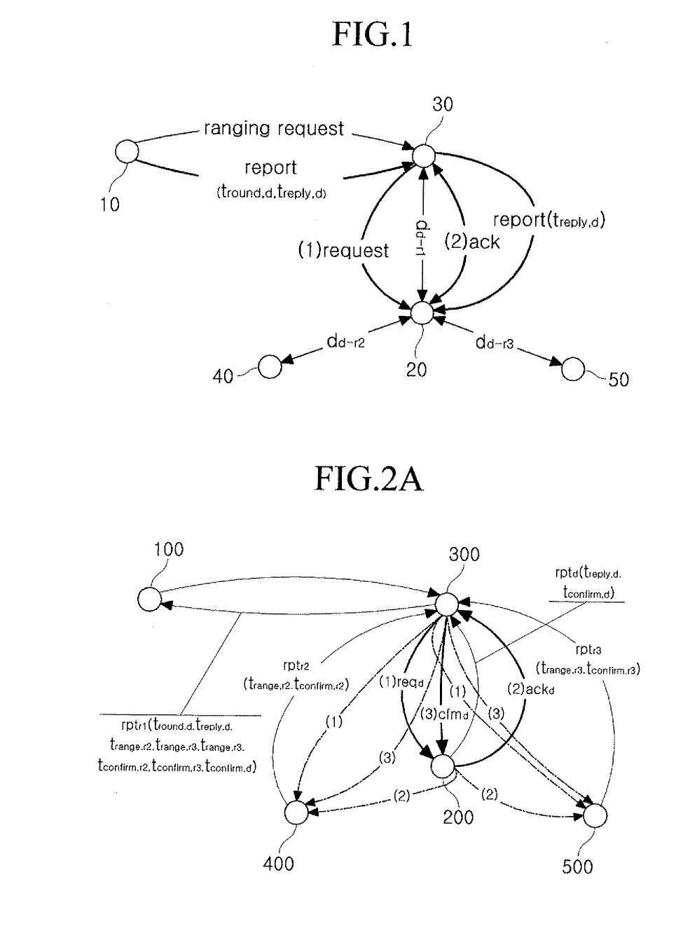

FIG. 2A is an exemplary view illustrating a TOA process of a system for tracking position according to an embodiment of the present invention;

FIG. 2B is an exemplary view illustrating parameters for a TOA measurement of FIG. 2A;

FIG. 3A is an exemplary view illustrating a TDOA process of a system for tracking position according to another embodiment of the present invention;

FIG. 3B is an exemplary view illustrating parameters for a TOA measurement of FIG. 3A;

FIG. 4 is a view of a node structure for tracking position according to an embodiment of the present invention;

FIGS. 5A and 5B are flowcharts illustrating a process of setting a message transmission/reception time when a controller measures distance in FIG. 4; and

FIG. 6 is an exemplary view illustrating the number of messages required for distance measurement according to the present invention.

### DETAILED DESCRIPTION OF EMBODIMENTS

Hereinafter, specific embodiments will be described in detail with reference to the accompanying drawings.

In the following description, specific details such as a system and a method for tracking position are described to provide more general understandings of the present invention. However, it is obvious to those skilled in the art that the present invention can be easily implemented even without the specific details or with the modifications.

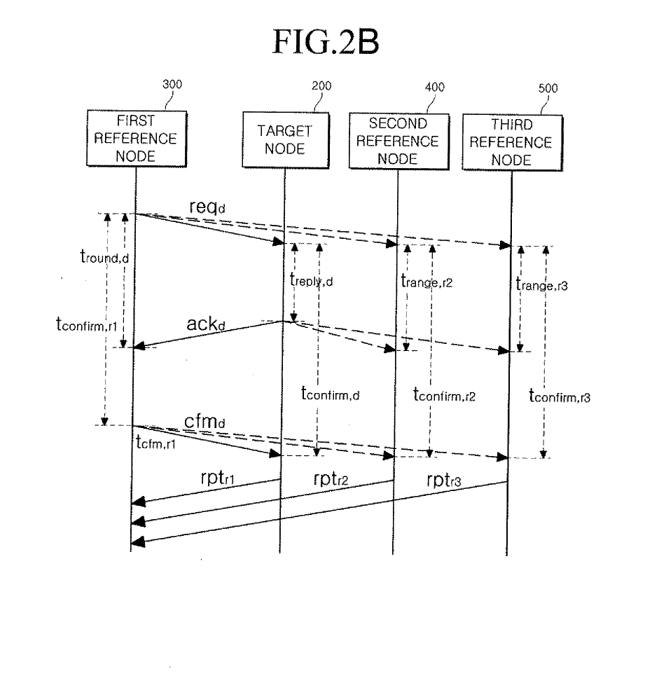

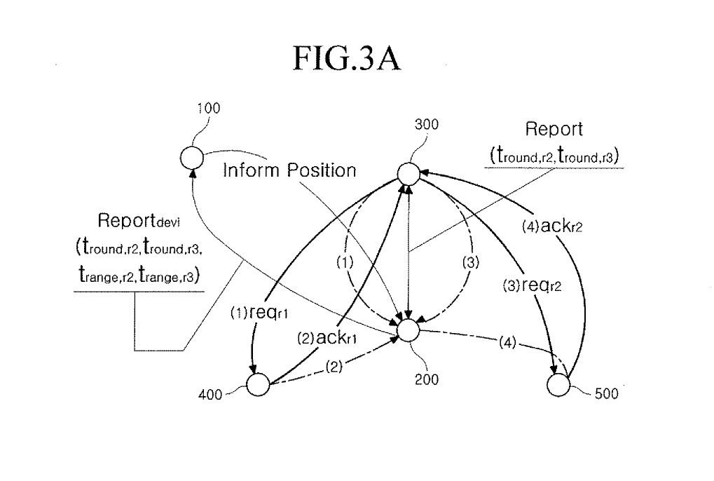

FIG. 2A is an exemplary view illustrating a time of arrival (TOA) process of a system for tracking position according to an embodiment of the present invention;

The system for tracking position includes one position determination device 100, a target node 200, and first to third reference nodes 300, 400, and 500. However, the above structure is only an example, and thus may include a plurality of target nodes 200 and additional reference nodes adjacent to the target nodes according to the present invention.

In the above structure, the position determination device 100 can request an arbitrary reference node 300, 400, or 500 of a wireless personal area network (WPAN), to which the target node 200 to be positioned belongs, to obtain distance measurement, or the target node 200 can request the reference nodes 300, 400, and 500 or the position determination device 100 for distance measurement to position itself.

Hereinafter, as one example for understanding operations of the present invention, let's assume that the target node 200 requests the first reference node 300 for distance measurement.

The first reference node 300 transmits a distance measurement request message req_{d} to the target node 200 when a distance measurement request is necessary. Then, the target node 200 transmits a reply message ack_{d} to the first reference node 300 in response to the distance measurement request message req_{d}. The first reference node 300 receiving the reply message ack_{d} transmits a confirmation message cfm_{d} to the target node 200 again.

The target node 200 receiving the confirmation message cfm_{d} transmits a report message rep_{d} to the first reference node 300. The report message rep_{d} contains a reply time t_{reply, d} and a confirmation time t_{confirm, d}. The reply time t_{rely, d} is a required time until the reply message ack_{d} is transmitted after receiving the distance measurement request message req_{d}. The confirmation time t_{confirm, d} is a time difference between a time of receiving the confirmation message cfm_{d} and a time of receiving the request message req_{d}.

At this point the second and third reference nodes 400 and 500 listen to a distance measurement process between the first reference node 300 and the target node 200. Then, the second and third reference nodes 400 and 500 examine a distance measurement time and a confirmation time t_{confirm, r2,} t_{confirm, r3}. The distance measurement time is a time difference between a time of receiving of a request message transmitted by the first reference node 300 and a time of receiving of a reply message transmitted by the target node 200. The confirmation time t_{confirm, r2,} t_{confirm, r3} is a time difference between a time of receiving the distance measurement request message req_{d} and a time of receiving the confirmation message cfm_{d}. Then, the second and third reference nodes 400 and 500 report a message reqᵣ₁, reqᵣ₂ containing the distance measurement time and the confirmation time t_{confirm, r2,} t_{confirm, r3} to the first reference node 300.

FIG. 2B is an exemplary view illustrating parameters for a TOA measurement of FIG. 2A.

In FIG. 2B, a required time until a reply message is received from the target node 200 after the first reference node 300 transmits a distance measurement request message to the target 200 is called a round trip delay time t_{round, d}, and a required time until a confirmation message is transmitted again after transmitting a request message is called a confirmation time t_{confirm, r1}. A required time until a reply message is transmitted after receiving a request message from the target node 200 is called a reply time t_{reply, d}, and a required time until the confirmation message is received after receiving the request message is called a confirmation time t_{confirm, d}. A required time until the reply message is received after receiving a distance measurement request message from the second and third reference nodes 400 and 500 is called a distance measurement time t_{range, r2}, t_{range, r2}, and a required time until the confirmation message is received after receiving the distance measurement request message is called a confirmation time t_{confirm, r2}, t_{confirm, r3}.

The first reference node 300 reports information, which contains a self-measured reception time and a reception time measured by the target node 200 and the second third reference nodes 400 and 500, to the position determination device 100, or calculates its position by itself.

A distance between two nodes is calculated to track position, and a clock offset between two nodes is corrected during distance calculation. A relative error ε_{d/r1} of two clocks is calculated using a confirmation time t_{confirm, r1} of the first reference node 300 and a confirmation time t_{confirm, r2} of the target node 200 through the following Equation (3). Furthermore, using the same method, a relative error ε_{r2/r1}, ε_{r3/r1} of the first reference node 300 and the second and third reference nodes 400 and 500 can be calculated.

ε_{d/r1}=(t_{confirm, d}, t_{confirm, r1})/t_{confirm, r1}

ε_{r2/r1}=(t_{confirm, r2}, t_{confirm, r1})/t_{confirm, r1}

ε_{r3/r1}=(t_{confirm, r3}, t_{confirm, r1})/t_{confirm, r1} (3)

The reply time t_{reply, d} measured by the target node 200 is divided by 1+ε_{d}, and (t_{reply, d}=t*_{reply, d}/1+ε_{d}) is corrected as a clock of the first reference node 300. Here, t*_{reply, d} represents a measured value, and t_{reply, d} represents an actual value. Using the same method, a reply time measured by the second and third reference nodes 400 and 500 can be corrected as a clock of the first reference node 300 for clock offset correction.

The distance t_{p, r1-d} between the first reference node 300 and the target node 200 can be calculated using the reply time t_{reply, d} corrected as a reference clock through the above Equation (1).

In the following, the position measurement device 100 calculates a signal propagation time between the target node 200 and the second and third reference node 400 and 500 using TOA received from the target node 200 through the following Equation (4). In addition, the position measurement device 100 calculates without considering the t_{cfm,r1} and the rptᵣ₁ signals in FIG. 2B a signal propagation time between the target node 200 and the second and third reference node 400 and 500 using TDOA received from the target node 200 through the following Equation (5).

t_{p, d-r2}=t_{range, r2}−(t_{p, r1-d}+t_{reply, d}−t_{p, r1-r2})

t_{p, d-r3}=t_{range, r3}−(t_{p, r1-d}+t_{reply, d}−t_{p, r1-r3}) (4)

TDOAᵣ₂₋ᵣ₁=t_{range, r2}+t_{p, r1-r2}−t_{reply, d}

TDOAᵣ₃₋ᵣ₁=t_{range, r3}+t_{p, r1-r3}−t_{reply, d} (5)

where t_{p, d-r1} represents a signal propagation time between the target node 200 and the first reference node 300, and t_{p, d-r2} represents a signal propagation time between the target node 200 and the second reference node 400. t_{rely, r1} represents a required time until a reply message is transmitted after the first reference node 300 receives a distance measurement request message. t_{p, r1-r2} represents a signal propagation time between the first reference node 300 and the second reference node 400. t_{range, r2} represents a required time until a reply massage is received after the second reference node 400 receives a distance measurement request message. t_{p, r3-d} represents a signal propagation time between the target node 200 and the third reference node 500. t_{p, r1-r3} represents a signal propagation time between the first reference node 300 and the third reference node 500. t_{p, d-r3} represents a signal propagation time between the target node 200 and the third reference node 500. t_{range, r3} represents a required time until a reply message is received after the third reference node 500 receives a distance measurement request message.

Thereafter, the position determination device 100 multiplies the signal propagation times by the propagation velocities to obtain the distance between the target node 200 and the second and third reference nodes 400 and 500, and then tracks a position of the target node 200 through position information and distance information of the second and third reference nodes 400 and 500.

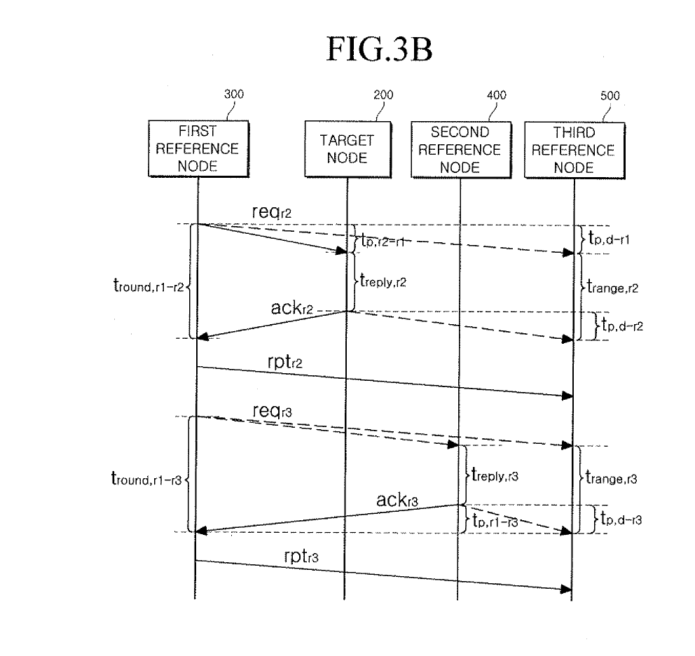

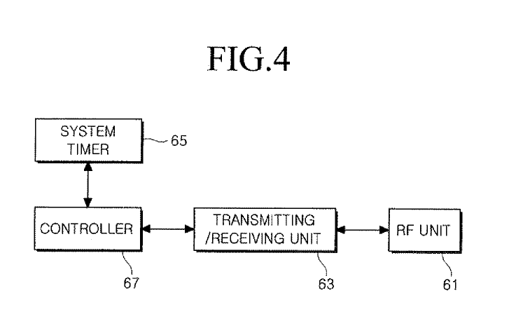

FIG. 3A is an exemplary view illustrating a time difference of arrival (TDOA) process of a system for tracking position according to another embodiment of the present invention.

There are one position determination device 100, a target node 200, and first to third reference nodes 300, 400, and 500. The first reference node 300 performs two-way ranging (TWR) on the second and third reference nodes 400 and 500, and the target node 200 listens to a TWR message to measure a reception time in order to calculate its position or requests the position determination device 100 for position calculation. If so, the determination device 100 performs the position calculation and then reports the result to the target node 200.

For example, when the first reference node 300 transmits a distance measurement request message reqᵣ₂ to the second reference node 400, the second reference node 400 receiving the distance measurement request message reqᵣ₂ transmits a reply message ackᵣ₂, and the first reference node 300 receiving the reply message ackᵣ₂ broadcasts a report message rptᵣ₂. When the first reference node 300 transmits a distance measurement message reqᵣ₃ to the third reference node 500, the third reference node 500 receiving the distance measurement message reqᵣ₃ transmits a reply message ackᵣ₃. The first reference node 300 broadcasts a report message rptᵣ₃ when receiving the reply message ackᵣ₃. At this point, the target node 200 measures a reception time of two TWR messages, and calculates its position through the broadcasted report messages rptᵣ₂ and rptᵣ₃, or requests the position determination device 100 for position determination. The report message includes a round trip delay time calculated through the TWR result.

FIG. 3B is an exemplary view illustrating parameters for a TDOA measurement of FIG. 3A.

A required time of when the first reference node 300 measures TWR with respect to the second reference node 400 is called a round trip delay time t_{round, r2}, and a required time in the second reference node 400 is called a reply time t_{reply, r2.} Additionally, a required time of when the first reference node 300 measures TWR with respect to the third reference node 500 is called a round trip delay time t_{round, r3}, and a required time in the second reference node 400 is called a reply time t_{reply, r2.} At this time, while the target node 200 listens to a transmitted/received distance measurement message that is used for calculating a distance difference between the first and second reference nodes 300 and 400, a time difference between a time of receiving a reply message ackᵣ₁ and a time of receiving a request message reqᵣ₂ is called a distance measurement time t_{range, r2}. While the target node 200 listens to a transmitted/received distance measurement message that is used for calculating a distance difference between the first and third reference nodes 300 and 500, a time difference between a time of receiving a reply message ackᵣ₃ and a time of receiving a request message reqᵣ₃ is called a distance measurement time t_{range, r3}.

The reply time t_{reply, r2} of the second reference node 400 is calculated through a round trip delay time calculated in the first reference node 300, and a signal propagation time calculated using a distance between the first reference node 300 and the second reference node 400. Using the same method, the reply time t_{reply, r3} of the third reference node 400 can be calculated.

An arrival time difference TDOAᵣ₂₋ᵣ₁ of the first and second reference nodes 300 and 400, which is measured using the parameters in the target node 200, can be obtained using the following Equation (6). Using the same method, TDOAᵣ₃₋ᵣ₁ can be obtained using the following Equation (6) when the first reference node 300 listens to TWR performed on the third reference node 500.

TDOAᵣ₂₋ᵣ₁=t_{range, r2}−t_{p, r1-r2}−t_{reply, r2}

TDOAᵣ₃₋ᵣ₁=t_{range, r3}−t_{p, r1-r3}−t_{reply, r3} (6)

The target node 200 recognizes its position through the two TDOAs, or requests the position determination device 100 for its position.

Each node requires a process of correcting a clock error, which can cause distance error. ε₁, ε₁, and ε₁ represent respective clock errors of the first to third reference nodes 300, 400, and 500. ε_{d} represents a clock error of the target node 200. The first reference node 300 performs TWR on the second and third reference nodes 400 and 500 to calculate an arrival time difference TDOA*_{r3-r2, r1} with respect to the second and third reference nodes 400 and 500 through Equation (7) below. Additionally, the second reference node 400 performs TWR on the first and third reference nodes 300 and 500 to calculate an arrival time difference TDOA*_{r3-r1, r2} with respect to the first and third reference nodes 300 and 500 through Equation (7) below. Furthermore, the second reference node 500 performs TWR on the first and second reference nodes 300 and 400 to calculate an arrival time difference TDOA*_{r2-r1, r3} with respect to the first and second reference nodes 300 and 400 through Equation (7) below. Here, at least two arrival time differences to calculate a position of the target node 200.

$$\begin{matrix}{TDOA}_{r 3 - r 2 , r 1}^{*} = {TDOA}_{r 3 - r 2}^{*} - {TDOA}_{r 2 - r 1}^{*} \\ = ( {t}_{m g , r 3}^{*} - {t}_{p , r 1 - r 3} - {t}_{reply , r 3}^{*} ) - \\ ( {t}_{m g , r 2}^{*} - {t}_{p , r 1 - r 2} - {t}_{reply , r 2}^{*} ) \\ = ( {t}_{m g , r 3} ( 1 + {ɛ}_{d} ) - {t}_{p , r 1 - r 3} - {t}_{reply , r 3} ( 1 + {ɛ}_{1} ) ) - \\ ( {t}_{m g , r 2} ( 1 + {ɛ}_{d} ) - {t}_{p , r 1 - r 2} - {t}_{reply , r 2} ( 1 + {ɛ}_{2} ) ) \\ = {TDOA}_{r 3 - r 2} ( 1 + {ɛ}_{d} ) + ( {t}_{p , r 1 - r 3} - {t}_{p , r 1 - r 2} ) {ɛ}_{d} + \\ ( {t}_{reply , r 3} - {t}_{reply , r 2} ) ( {ɛ}_{d} - {ɛ}_{1} )\end{matrix} \qquad ( 7 )$$

where TDOAᵣ₃₋ᵣ₂ represents an actual value of an arrival time difference, and TDOA*_{r3-r2, r1} represents a measured value of an arrival time difference. An error of the measured TDOA*_{r3-r2, r1} is calculated through the follows Equation (8).

Moreover, because a range of a WPAN is several meters, a signal propagation time is only several nsec, but a reply time t*_{reply, r2}, t*_{reply, r3} is generally hundreds μsec. Therefore, the signal propagation time can be omitted for simplification, which is expressed as Equation (8).

TDOA*_{r3-r2, r1}−TDOAᵣ₃₋ᵣ₂=TDOAᵣ₃₋ᵣ₂ ε_{d}+(t_{p, r1-r3}−t_{p, r1-r2})ε_{d}+(t*_{reply, r3}−t*_{reply, r2})(ε_{d}−ε₁)÷(t*_{reply, r3}−t*_{reply, r2})(ε_{d}−ε₁) (8)

That is, because it is proportional to a difference of t*_{reply, r3} and t*_{reply, r2}, when the difference is decreased, distance error due to a clock error can be reduced. Using the same method, the second reference node 400 calculates TDOA*_{r3-r1, r2} from TWR results of the first and third reference nodes 300 and 400.

For example, if a reply time difference of two reference nodes is 10 μsec, and a clock error is 40 ppm, a measurement error caused by a clock offset is 0.8 nsec (24 cm). If a clock error is corrected, distance accuracy of several cm can be achieved through a clock with an error of several ppm.

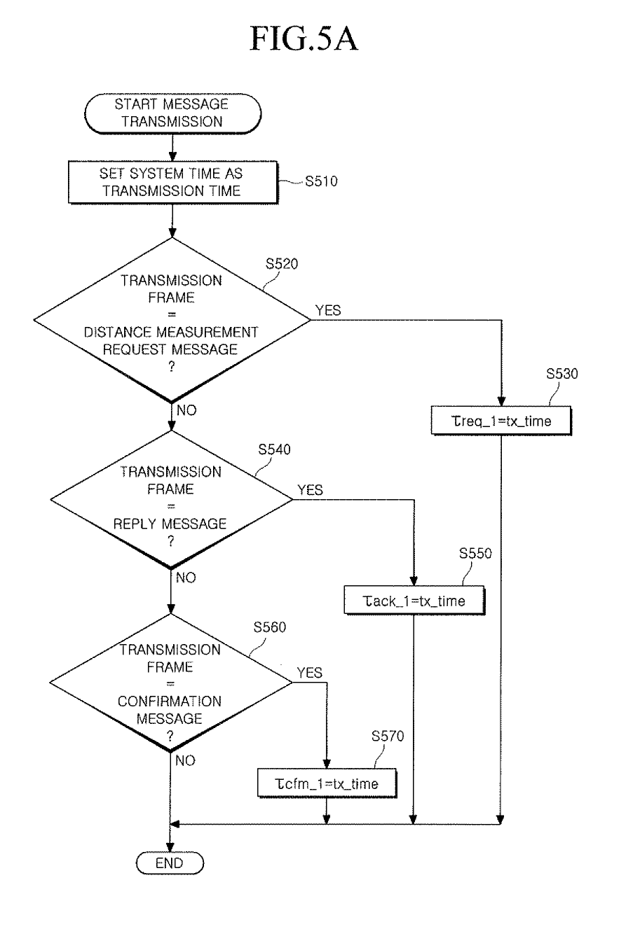

FIG. 4 is a view of a node structure for tracking position according to an embodiment of the present invention. The node means a target node 200 and first to third reference nodes 300, 400, and 500.

The node includes an RF unit 61, a transmitting/receiving unit, a system timer 65, and a controller 67.

The RF unit 61 includes an RF transmitter (not shown) that up converts and amplifies a frequency of a transmitted signal, and then transmits the frequency to an antenna ANT, and an RF receiver (not shown) that low noise amplifies the signal received through the antenna ANT and down converts the frequency.

The transmitting/receiving unit 63 codes transmission data in an UWB signal necessary for a WPAN, and then converts the UWB signal into an analog signal in order to output the analog signal to the RF unit 61. At this point, in a case of a distance measurement message, a transmission time is recorded according to a distance measurement bit. Additionally, the transmitting/receiving unit 63 converts the analog signal received from the RF unit 61 into a digital signal and demodulates the digital signal. Then, a reception frame is transmitted to an upper layer (not shown) by the transmitting/receiving unit 63.

The system timer 65 counts a transmission and reception time according to a distance measurement message.

The controller 67 controls the system timer 65 to measure a transmission time or a reception time according to a distance measurement bit if the transmission data transmitted by the transmitting/receiving unit 63 is a distance measurement message.

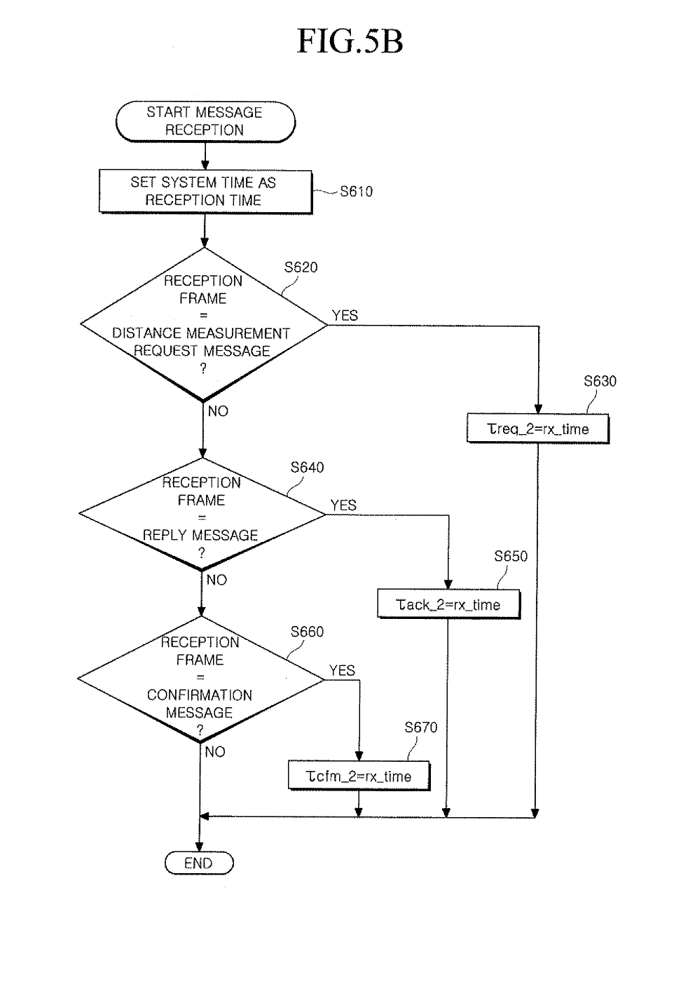

FIGS. 5A and 5B are flowcharts illustrating a process of setting a message transmission/reception time when a controller measures distance in FIG. 4. FIG. 5A is a flowchart illustrating a process of setting a time when a distance measurement message is transmitted, and FIG. 5B is a flowchart illustrating a process of setting a time when a distance measurement message is received.

As illustrated in FIG. 5A, the controller 67 sets a system system_time of when the transmitting/receiving unit 63 transmits a distance measurement bit as a transmission time tx_time in operation S510, and it is determined whether the transmission frame is a distance measurement request message or not in operation S520.

If the transmission frame is the distance measurement request message, the controller 67 sets the transmission time tx_time as a time τ_{req}_{_{—}}₁ of when a node transmits the distance measurement request message in operation S530.

However, if the transmission frame is not the distance measurement request message, the controller 67 determines whether the transmission frame is a reply message or not in operation S540.

If the transmission frame is the reply message, the controller 67 sets the transmission time tx_time as a time τ_{ack}_{_{—}}₁ of when the reply message is transmitted in operation S550.

If the transmission frame is not the reply message, the controller 67 determines whether the transmission frame is a confirmation message or not in operation S560.

If the transmission frame is the reply message, the controller 67 sets the transmission time tx_time as a time τᵣₚₜ_{_{—}}₁ of when the conformation message is transmitted in operation S560.

On the other hand, as illustrated in FIG. 513, the controller 67 sets a system system_time of when the transmitting/receiving unit 63 receives a distance measurement bit as a reception time rx_time in operation S610, and it is determined whether the reception frame is a distance measurement request message or not in operation S620.

If the reception frame is the distance measurement request message, the controller 67 sets the reception time rx_time as a time τ_{req}_{_{—}}₂ of receiving the distance measurement request message in operation S630.

However, if the reception frame is not the distance measurement request message, the controller 67 determines whether the reception frame is a reply message or not in operation S640.

If the reception frame is the reply message, the controller 67 sets the reception time rx_time as a time τ_{ack}_{_{—}}₂ of receiving the reply message in operation S650.

If the reception frame is not the reply message, the controller 67 determines the reception frame is a confirmation message or not in operation S660.

If the reception frame is the confirmation message, the controller 67 sets the reception time rx_time as a time τᵣₚₜ_{_{—}}₁ of receiving the confirmation message in operation S660.

The controller 67 calculates t_{round}, t_{reply}, and t_{confirm} through the arrival time information obtained through the above process.

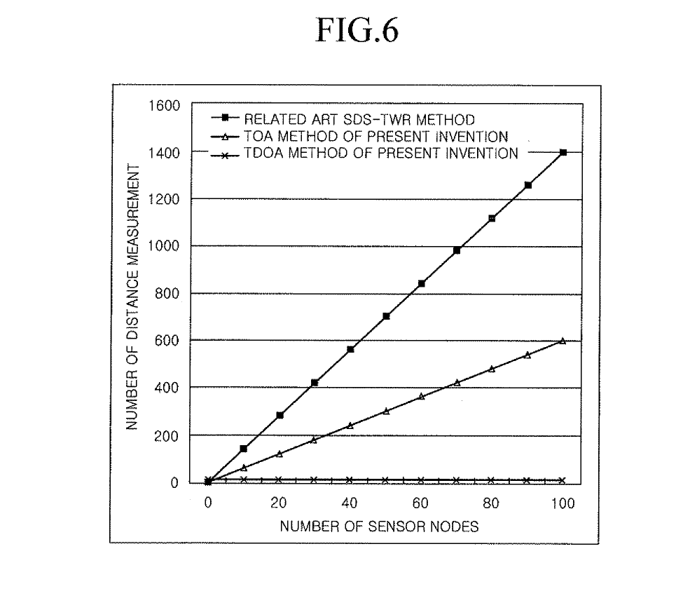

FIG. 6 is an exemplary view illustrating the number of messages required for distance measurement according to the present invention.

A related art SDS-TWR measuring method requires 14 messages including at least 12 distance measurement messages from three reference nodes with respect to one target node to be positioned and 2 messages sending the measured result to one reference node. Therefore, if there are 100 target nodes, 1400 distance measurement messages are required. In a case of TWR, to recognize a portion of one target node, 11 distance measurement messages are required. Therefore, if there are 100 target nodes, 1100 messages are required and distance error occurs due to a clock error.

According to the TOA measuring method based on TWR between one reference node and a target node, 6 distance measurement messages are required with respect to one target node. Therefore, if there are 100 target nodes, 600 distance measurement messages are required.

On the other hand, the TDOA measuring method based on TWR between reference nodes is irrelevant to the number of target nodes, and 12 distance measurement messages are required with respect to one reference node. Even though there are 100 target nodes, 12 distance measurement messages are required regardless of the number of target nodes.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalents of such metes and bounds are therefore intended to be embraced by the appended claims.

What is claimed is:

1. A position tracking system comprising:
at least one target node;
a plurality of reference nodes having position information; and
a position determination device,
wherein an arbitrary reference node among the reference nodes and the target node utilize a distance measurement message to measure a first time of arrival (TOA) and then transmit the first TOA to the position determination device; and
at least two other reference nodes adjacent to the arbitrary reference node and the target node listen to the distance measurement message to measure a second TOA and then transmit the second TOA to the position determination device, in order to track a position of the target node.

2. The position tracking system of claim 1, wherein the position determination device corrects a clock error measured in advance between the reference nodes and the target node to track a position of the target node after collecting the first and second TOAs.

3. The position tracking system of claim 1, wherein when the reference node transmits a timer start message and a timer stop message, the position determination device corrects a clock error through a time difference between a time of when the reference node transmits the timer start message and the timer stop message and a time of when the target node receives the timer start message and the timer stop message.

4. The position tracking system of claim 3, wherein the clock error is measured using a reference clock through a multi-hop.

5. A position tracking system comprising:
at least one target node;
a plurality of reference nodes having position information; and
a position determination device for tracking a position of a target node,
wherein an arbitrary reference node among the reference nodes utilizes a distance measurement message to measure a first TOA between the reference nodes, and then transmit the first TOA to the position determination device;
the target node listens to the distance measurement message to measure a second TOA and then transmits the second TOA to the position determination device; and
the position determination device measures a time difference of arrival (TDOA) of difference information between the first and second TOAs in order to track a position of the target node.

6. The position tracking system of claim 5, wherein the location determination device tracks a position of the target node through TDOA information that is corrected using clock errors of the target node and corresponding reference nodes during the measuring of the TDOA.

7. A position tracking method using a position tracking device, the position tracking device including at least one target node, a plurality of reference nodes having position information, and a position determination device tracking a position of a target node, the method comprising:
measuring a first TOA by using a distance measurement message in an arbitrary reference node among the reference nodes and the target node;
measuring a second TOA by listening to the distance measurement message in reference nodes adjacent to the arbitrary reference node and the target node; and
tracking a position of the target node through the first and second TOAs in the position determination device.

8. The method of claim 7, wherein the tracking of the position comprises correcting a clock error measured in advance between the reference nodes and the target node after collecting the first and second TOAs.

9. A position tracking method using a position tracking device, the position tracking device including at least one target node, a plurality of reference nodes having position information, and a position determination device tracking a position of a target node, the method comprising:
measuring a first TOA between the reference nodes through a distance measurement message in an arbitrary reference node among the reference nodes;
measuring a second TOA by listening to the distance measurement message in the target node; and
tracking a position of the target node by measuring a TDOA through the first and second TOAs in the position determination device.

10. The method of claim 9, wherein the tracking of the position of the target node comprises utilizing TDOA information that is corrected using clock errors of the target node and corresponding reference nodes during the measuring of the TDOA.
